(19) United States
(12) Patent Application Publication
(10) Pub. No.: US 2022/0267002 A1
(43) Pub. Date: Aug. 25, 2022

(54) DRONE FOR CLEANING OUTER WALL OF HIGH-RISE BUILDING

(71) Applicant: IVESKY CO., LTD., Busan (KR)

(72) Inventor: Gill Do LEE, Busan (KR)

(73) Assignee: IVESKY CO., LTD., Busan (KR)

(21) Appl. No.: 17/636,810

(22) PCT Filed: Aug. 13, 2020
(86) PCT No.: PCT/KR2020/010770

§ 371 Date: Feb. 18, 2022

(30) Foreign Application Priority Data
Aug. 19, 2019 (KR) 10-2019-0100950

(51) Int. Cl. B64C 39/02; B64D 1/18; B64C 25/36; B64D 47/08; A47L 11/38; A47L 11/40; A47L 1/02; B05B 3/02

(52) U.S. Cl. CPC B64C 39/024; B64D 1/18; B64C 25/36; B64D 47/08; A47L 11/38; A47L 11/4002; A47L 11/4072; A47L 11/4088; A47L 11/4036; A47L 1/02; B05B 3/026; B64C 2201/127; A47L 2201/04

(57) ABSTRACT

A drone for cleaning an outer wall of a high-rise building is configured to float and move in the air. The drone includes a drone main body and a floating transfer unit for floating and moving the drone main body in the art. The drone main body has a camera unit provided to photograph the exterior of a building and driving wheels on one surface thereof to be guide to the exterior of the building. The drone main body further has a buffer angle member to cushion an impact with the building and a washing nozzle unit which sprays water onto and washes the exterior of the building. Accordingly, by cleaning the exterior or a window of a skyscraper using the drone, there are the effects of reducing the costs of cleaning a skyscraper, simplifying a cleaning operation, preventing human accidents due to falls, and reducing cleaning time.

### TECHNICAL FIELD

The present invention relates to a drone for cleaning an outer wall of a high-rise building, and more particularly, a drone floating and moving in the air which is used to clean an exterior surface or windows of a high-rise building, so that cleaning costs for the high-rise building can be reduced, cleaning work can be simplified, personal accidents due to falls may be prevented, and a cleaning work time may be shortened.

### BACKGROUND ART

With regard to the cleaning work. of the exterior wall of a high-rise building, there are many high-rise buildings which. are difficult to be cleaned on the ground by workers. As business buildings or residential buildings become high-rise and, in particular, highrise buildings, of which. outer walls are finished with glass windows for aesthetic reasons, are increasing, the demand for cleaning work of such high-rise buildings is also being increased.

Currently, such cleaning work is performed by installing a scaffold that can be moved up and down by a tow line installed on the roof of a building, and a worker gets on the scaffold and manually cleans the exterior wall and windows of the building.

Due to the cost of cleaning a high-rise building such as a skyscraper by manpower and/or safety concerns in the cleaning work, there is a demand for simplification of building cleaning work and automation using mechanical devices.

The above-described invention refers to a. background technology the technical field to which the present invention pertains, and does not mean the prior art.

Prior art documents in the technical field to which the present invention pertains include Korean Patent Registration No. 0938701 or the like.

### DISCLOSURE

### Technical Problem

The present invention has been conceived to solve the above-described problems in the related art, and an object of the present invention is to provide a drone for cleaning an outer wadl of a high--rise building such as a skyscraper, wherein the drone may float and move in the air to clean the outer wall or windows of the high-rise building, whereby cleaning costs of the high-rise building can be reduced, cleaning work may be simplified, personal accidents due to falls may be prevented, and a cleaning work time may be shortened.

### Technical Solution

The present invention provides a drone designed to float and move in the air, which includes a drone body and a floating transfer unit to float and. move the drone body in the air, wherein the drone body is provided with: a camera unit to photograph an outer surface of a building a drive wheel mounted on one side thereof in. order to guide the drone to the outer surface of the building; a buffer angle member formed to buffer (or absorb) impact. with the building; and a washing nozzle member to inject water to the outer surface of the building so as to wash the same.

Further, the drone body may be provided with a connection guide to connect the drone to a safety support provided in the building, wherein the connection guide may include connection rings formed on the drone body, a lifting motor to be mounted on the safety support, and a safety wire for connecting the connection rings the lifting motor.

Further, the drone body may be provided with a washing nozzle rotating means to inject water onto the outer surface of the building while rotating the washing nozzle member, wherein the washing nozzle rotating means may include: an operating hole formed on a top surface of the drone body; a guide bearing fitted into the operating hole; a rotary shaft in which a lower end thereof is coupled to the guide bearing fitted into the operating hole in order to rotate the rotary shaft and an upper end thereof is connected to the washing nozzle member; and a pivot cylinder fixed to the top surface of the drone body while having a pivot shaft hinge-coupled to the washing nozzle member, in addition, the drone body may further be provided with a driven washing member to wash the outer surface of the building, to which water was injected through. the washing nozzle member, wherein the driven washing member may include: a drive motor mounted on the top surface of the drone body; a rotational panel that is mounted on a rotational axis of the drive motor and is rotated by driving the drive motor; and a cleaning sheet that is attached to one side of the rotational panel and disposed to be in contact with. the outer surface of the building in order to rub and wipe the outer surface of the building by driving the drive motor,

Further, the drone body may be provided with a movable washing means to transport the driven washing member, wherein the movable washing means may include: a rail groove formed on the top surface of the drone body; a transfer cart having a guide roller mounted on a bottom surface thereof to be guided along the rail groove; an elastic buffer panel mounted on one side of the transfer cart; a support panel attached to the elastic buffer panel; a transfer cylinder fixed to the top surface of the drone body to transport the transfer cart; and an elastic coil spring in which one end is fixed to a transfer shaft of the transfer cylinder and the other end is fixed to the support panel to thus connect the transfer shaft and the support panel. In addition, a female Velcro tape may be attached to the rotational panel while a male Velcro tape may be attached to the cleaning sheet so as to be detachably attached. to the female Velcro tape.

### Advantageous Effects

The drone for cleaning an outer wall of a high-rise building according to the present invention, which floats and moves in the air, may be used to wash and clean the outer surface of the high-rise building, thereby attaining effects of reducing costs for cleaning the outer wall of the high-rise building simplifying cleaning work, preventing personal accidents due to falls, and shortening a cleaning work time.

### DESCRIPTION OF DRAWINGS

FIG. 1 is a perspective view showing a drone for cleaning the outer wall of a high-rise building according to the present invention.

FIG. 2 is a plan view showing the drone for cleaning the outer wall of a high-rise building according to the present invention.

FIG. 3 is a side view showing the drone for cleaning the outer wall of a high-rise building according to the present invention.

FIG. 4 is a perspective side view showing the drone for cleaning the outer wall of high-rise building according to the present invention.

FIG. 5 is a diagram illustrating an installation state of the drone for cleaning the outer wall of a high-rise building according to the present invention.

FIG. 6 is a perspective view showing a driven washing member in the drone for cleaning the outer wall of a high-rise building according to the present invention.

FIG. 7 is a diagram illustrating an operational state of the drone for cleaning the outer wall of a high-rise building according to the present invention.

FIG. 8 illustrates another embodiment of the drone for cleaning the outer wall of high-rise building according to the present invention.

9 FIG. 9 illustrates another embodiment of the drone for cleaning the outer wall of a high-rise building according to the present invention.

FIG. 10 illustrates another embodiment of the drone for cleaning the outer wall of a high-rise building according to the present invention.

### DETAILED DESCRIPTION OF PREFERRED EMBODIMENTS OF INVENTION

Hereinafter, preferred embodiments of the drone for cleaning the outer wall of a high-rise building according to the present invention will be described in detail with reference to the accompanying drawings. In this process, thicknesses of lines or sizes of components shown in the drawings may be exaggerated for clarity and convenience of description. Further, terms described later are those defined in consideration of functions in the present invention and may vary according to the intension of users or operators or customs. Therefore, definitions of these terms should be made based on contents throughout the present specification.

Further, the following examples are not intended to restrict the scope of the present invention but are present merely as examples, and there may be various embodiments implemented through the present technical idea.

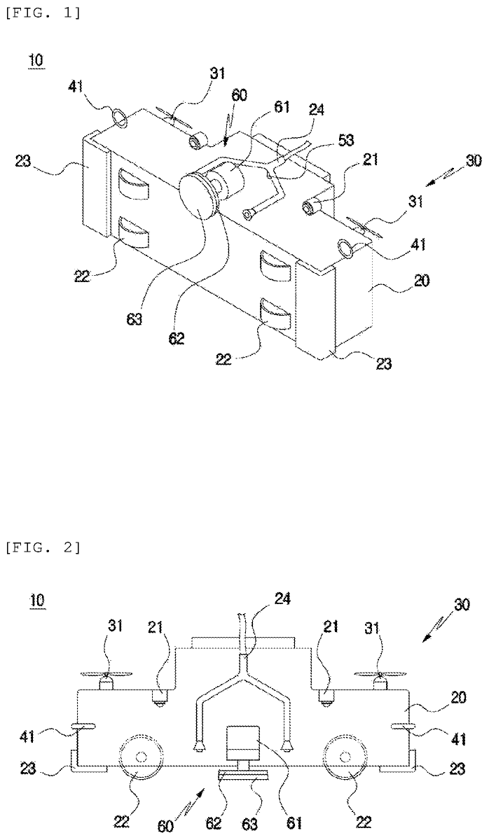

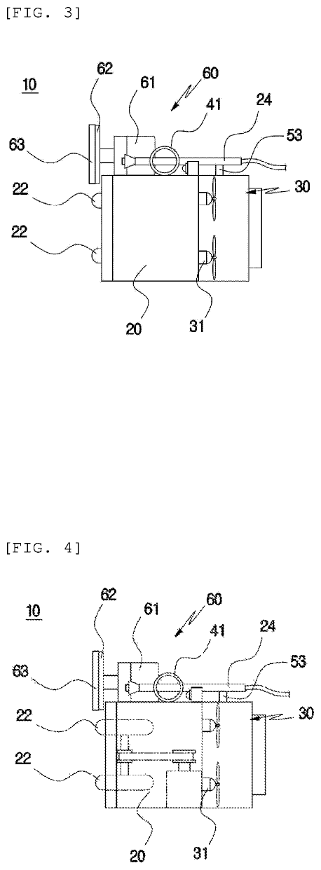

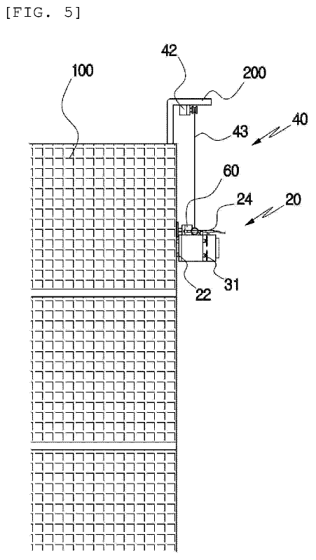

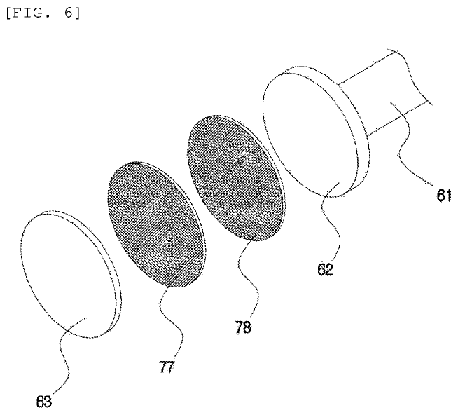

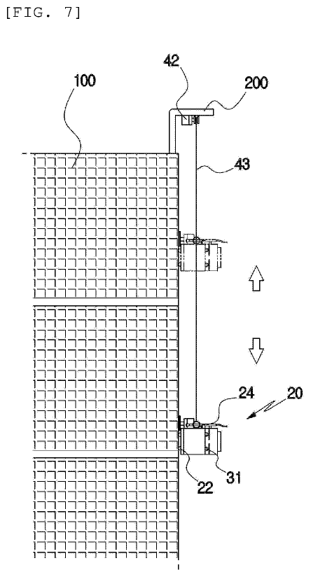

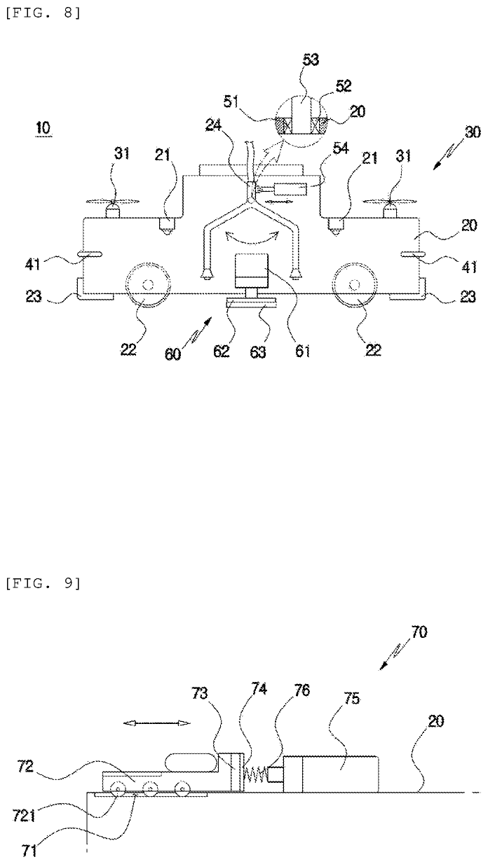

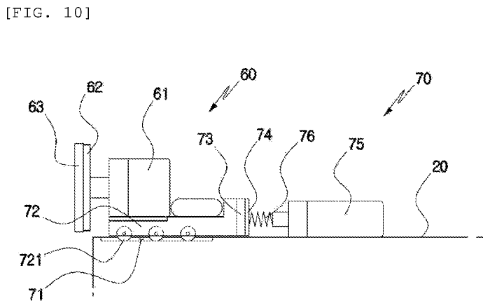

FIG. 1 is a perspective view showing a drone for cleaning the outer wall of a high-rise building according to the present invention; FIG. 2 plan view showing the drone for cleaning the outer wall of a high-rise building according to the present invention; FIG. 3 is a side view showing the drone for cleaning the outer wall of a high-rise building according to the present invention; FIG. 4 a perspective side view showing the drone for cleaning the outer wall of a high-rise building according to the present invention; FIG. 5 is a diagram illustrating an installation state of the drone for cleaning the outer wall of a high-rise building according to the present invention; FIG. 6 is a perspective view showing a driven washing member in the drone for cleaning the outer wail of a high-rise building according to the present invention; FIG. 7 is a diagram illustrating an operational state of the drone for cleaning the outer wall of a high rise building according to the Present invention; FIG. 8 illustrates another embodiment of the drone for cleaning the outer wall of a high-rise building according to the present invention; FIG. 9 illustrates another embodiment of the drone for cleaning the outer wall of a high-rise building according to the present invention; and FIG. 10 illustrates another embodiment of the drone for cleaning the outer wall of a high-rise building according to the present invention.

As shown in the drawings, a drone 10 for cleaning an outer wail of a high-rise building (hereinafter referred to as a “cleaning drone” for convenience of description) floats and moves in the air while injecting water on an outer surface of the building 100 to thus wash and clean the same, and may include a drone body 20 and a floating transfer unit 30.

The drone body 20 may be made of a synthetic resin or metal material, and may be formed in a rectangular housing structure. The drone body 20 may also be formed in a circular or polygonal housing structure other than the rectangular form.

Alternatively, the drone body 20 may be possibly formed in a rectangular, circular or polygonal panel structure or a frame structure.

The floating transfer unit 30 is for floating and moving the drone body 20 in the air, and may include a floating motor provided in the drone body 20, as well as floating units 31 consisting of floating wings that are connected to an axis of the floating motor for rotation. The floating motor may be seated and fixed inside a protective cap screwed to an outer surface of the drone body 20, and the floating wings may be fitted and fixed in an axis arranged outside through the protective cap.

The floating units 31 may be installed on a rear side of the drone body 20 to move the drone body 20 toward the outer surface of the building 100. Further, the floating units 31 may be provided on a top surface of the drone body 20 to float the drone body 20 in the air.

Specifically, four of the floating units 31 may be mounted on the rear side of the drone body 20 while the remaining four of the floating units may be provided on the top surface of the drone body.

The floating motor may be supplied with electricity by a battery provided inside the drone body 20, or may be connected by electric wires to possibly receive electricity from the outside.

Further, a camera unit 21 may further be provided on the drone body 20 through thread-coupling in order to photograph the outer surface of the building 100, and the drone body 20 may further be provided with a drive wheel 22 on one side thereof, which guides the drone body 20 to the outer surface of the building 100 and prevents collision to the building 100, a buffer angle member 23 made of a synthetic resin material having elasticity at an edge portion thereof may be attached to the drone body 20 in order to buffer (or absorb) impact with the building 100, and a washing nozzle member 24 may be formed on the drone body 20 in order to inject water on the outer surface of the building 100 to complete cleaning.

Further, the drone body 20 may be provided with a wireless transmission and reception member, wherein image information photographed by the camera unit 21 may be transmitted to a wireless controller through the wireless transmission and reception member and then checked, and wherein the floating motor may be controlled by the wireless controller to thus control movement of the drone body 20. Further, the drone body 20 may be provided with a central control unit, which is electrically connected with the wireless transmission and reception member and the floating motor, thereby receiving a control signal and controlling the floating motor.

The drive wheels 22 may be fixed to both ends of a pair of wheel shafts provided in the drone body 20, and the wheel shafts may be connected by a wheel driving motor and a belt provided inside a housing body, thereby moving through driving of the wheel driving motor. The wheel driving motor may be electrically connected to the central control unit.

While the drive wheel 22 presses the outer surface of the building 100 by driving the floating unit 31 mounted on the rear side of the drone body 20, the drone body 20 may move along the outer surface of the building 100 by driving the wheel driving motor. At the same time, the drone body may inject water through the washing nozzle member 24 while moving, thereby washing and cleaning the outer surface of the building 100.

At this time, the floating unit 31 provided on the top surface of the drone body 20 may play a role of moving the drone body 20 to a predetermined height in the air and then maintaining the moved height during cleaning.

Further, inside the drone body 20, a water tank may be provided and connected with the washing nozzle member 24 in order to fill the tank with water, wherein a pump is mounted on the water tank to feed water to the washing nozzle member 24. Otherwise, it is also possible that a connection hose is connected to the washing nozzle member 24 in order to supply water from the outside (outside the building to be cleaned) to the washing nozzle member.

Further, the drone body 20 may be provided with a connection guide 40 to connect the drone body to a safety support 200 provided in the building 100, wherein the connection guide 40 may include: connection rings 41 formed on the drone body 20; a lifting motor 42 to be mounted on the safety support 200; and a safety wire 43 to connect the connection rings 41 and the safety support 200, and wherein the drone body 43 may move up and down, as shown in the drawings, by driving the lifting motor 42. Therefore, it is not necessary to form the floating unit 31 on the top surface of the drone body 30.

The safety wire 43 is wound around a lifting axis of the lifting motor 42 and an end of the safety wire 43 is bundled and fixed to the connection rings 41.

Further, the drone body 20 may be provided with a washing nozzle 24 rotating means to inject water onto the outer surface of the building 100 while rotating the washing nozzle member 24, wherein the washing nozzle 24 rotating means may include: an operating hole 51 formed on the top surface of the drone body 20; a guide bearing 52 fitted into the operating hole 51; a rotary shaft 53 in which a lower end thereof is coupled to the guide bearing 52 fitted into the operating hole 51 in order to rotate the rotary shaft and an upper end thereof is connected to the washing nozzle member 24; and a pivot cylinder 54 screwed and fixed to the top surface of the drone body 20 while having a pivot shaft hinge-coupled to the washing nozzle member 24, so that the pivot shaft can move by driving the pivot cylinder 54 to rotate the washing nozzle member 24 so as to inject the water, thereby widening a water injection range.

The drone body may further be provided with a driven washing member 60 to wash the outer surface of the building, to which water was injected through the washing nozzle member 24, wherein the driven washing member 60 may include: a drive motor 61 screwed and fixed to a top surface of the drone body 20; a rotational panel 62 that is mounted on a rotational axis of the drive motor 6i is rotated by driving the drive motor 61, and is arranged to protrude outward from the drone body 20; and a cleaning sheet 63 that is attached to one side of the rotational panel 62 and disposed to be in contact with the outer surface of the building 100 in order to rub and wipe the outer surface of the building by driving the drive motor 61.

The cleaning sheet 63 may be formed of a nonwoven fabric or a synthetic fiber material.

Because of the cleaning sheet 63 rotated by the drive motor 61 as well as water injected from the washing nozzle member 24, foreign materials or dust. formed. on the outer surface of the building 100 can be washed out and removed.

Further, the drone body 20 may be provided with movable washing means 70 to transport the driven washing member 60, wherein the movable washing means 70 may include: a rail groove 71 formed on the top surface of the drone body 20; a transfer cart 72 having a guide roller 721 mounted on a bottom surface thereof to be guided along the rail groove 71; an elastic buffer panel 73 that is made of a synthetic resin material having elasticity and is mounted on one side of the transfer cart 72 through thread-coupling; a support panel 74 that is made of a metal or synthetic resin material and is attached to the elastic buffer panel 73; a transfer cylinder 75 screwed and fixed to the top surface of the drone body 20 to transport the transfer cart and an elastic col spring 76 in which one end is welded and fixed to a transfer shaft of the transfer cylinder 75 and the other end is welded or adhered to the support panel 74 to thus connect the transfer shaft and the support panel 74. Therefore, when the transfer cart 72 moves by driving the transfer cylinder 75, the drive motor 61 and the cleaning sheet 63 may press the outer surface of the building 100 while rotating the cleaning sheet 63 to clean the outer surface, thereby improving cleaning efficiency. Further, elastic action of the elastic coil spring 76 and the support panel 74 may buffer (or absorb) a pressing force of the cleaning sheet 63 to press the outer surface of the building 100 and, at the same time, may prevent a window or an outer wall of the building 100 from being damaged due to the pressing force because the transfer cart 72 is moved by the guide roller 721 without friction, and may further improve cleaning efficiency.

Further, a female Velcro tape 77 may be attached to the rotational panel 52 while a male Velcro tape 78 may be attached to the cleaning sheet 63 so as to be detachably attached to the female Velcro tape 77. Therefore, the cleaning sheet 63 may be easily replaced and used.

At this time, a vibration device, that is, a vibrator may be screwed and fixed to an upper portion of the transfer cart 72 so that vibration of the vibrator is transferred to the drive motor 61 and the cleaning sheet 63 through the transfer cart 72, which in turn is transferred to the outer wall and windows of the building, thereby preferably increasing foreign material release efficiency and cleaning efficiency.

In addition, by fusing and fixing one ends of elastic pins to one side of the cleaning sheet 63, these pins may rub and scrape foreign materials and dust formed on the exterior wall and/or windows of the building while rotating along with the cleaning sheet 63 under rotation, thereby preferably improving foreign material release efficiency and cleaning efficiency.

One embodiment of the present invention described above is merely illustrative, and those skilled in the art to which the present invention pertains will appreciate that various modifications and other equivalent embodiments are possible. Therefore, it will be appreciated that the present invention is not restricted to the form mentioned in the detailed description above. Accordingly, the true technical scope of the present invention to be protected should be determined by the technical spirit of the appended claims. In addition, the present invention is to be understood. as including all modifications, equivalents and substitutes within the spirit and scope of the present invention as defined in the appended claims.

### DESCRIPTION OF REFERENCE NUMERALS

10: Cleaning drone 20: Drone body

21: Camera unit 22: Drive wheel

23: Buffer angle member 24: Cleaning nozzle member

30 Floating transfer member 31: Floating unit

40: Connection guide 41: Connection ring

42: Lifting motor 43: Safety wire

50: Washing nozzle rotating means 51: Operating hole

52: Guide bearing 53: Rotary shaft

54: Pivot cylinder 60: Driven washing member

61: Drive motor 62: Rotational panel

63: Cleaning sheet 70: Movable washing means

71: Rail groove 72: Transfer cart

721: Guide roller 73: Elastic buffer panel

74: Support panel 75: Transfer cylinder

76: Elastic coil spring

77: Female Velcro tape

78: Male Velcro tape

100: Building

200: Safety support.

1. A drone for cleaning an outer wall of a high-rise building, which floats and moves in an air, comprising a drone body and a floating transfer unit to float and move the drone body in the air,
wherein the drone body is provided with: a camera unit to photograph an outer surface of a building;
a drive wheel mounted on one side thereof in order to guide the drone to the outer surface of the building;
a buffer angle member formed to buffer impact with the building; and
a washing nozzle member to inject water to the outer surface of the building so as to clean the same.

2. The drone according to claim 1, wherein the drone body is further provided with: a connection guide to connect the drone to a safety support provided in the building,
wherein the connection guide includes: connection. rings formed on the drone body;
a lifting motor to be mounted on the safety support; and
a safety wire for connecting the connection rings the lifting motor.

3. The drone according to claim 1, wherein the drone body is further provided with a washing nozzle rotating means to inject water onto the outer surface of the building while rotating the washing nozzle member, wherein the washing nozzle rotating means includes: an operating hole formed on a top surface of the drone body;
a guide bearing fitted into the operating hole;
a rotary shaft in which a lower end thereof is coupled to the guide bearing fitted into the operating hole in order to rotate the rotary shaft and an upper end thereof is connected to the washing nozzle member; and
a pivot cylinder fixed to the to surface of the drone body while having a pivot shaft hinge coupled to the washing nozzle member, and
wherein the drone body is further provided with a driven washing member to wash the outer surface of the building, to which water was injected through the washing nozzle member, wherein the driven washing member includes: a drive motor mounted on a top surface of the drone body;
a rotational panel that is mounted on a rotational axis of the drive motor and is rotated by driving the drive motor; and
a cleaning sheet that is attached to one side of the rotational panel and disposed to be in contact with the outer surface of the building in order to rub and wipe the outer surface of the building by driving the drive motor.

4. The drone according to claim 3, wherein the drone body is further provided with a movable washing means to transport the driven washing member, wherein the movable washing means includes:
a rail groove formed on the top surface of the drone body;
a transfer cart having a guide roller mounted on a bottom surface thereof to be guided along the rail groove;
an elastic buffer panel mounted on one side of the transfer cart;
a support panel attached to the elastic buffer panel;
a transfer cylinder fixed to the top surface of the drone body to transport the transfer cart; and
an elastic coil spring in which one end is fixed to a transfer shaft of the transfer cylinder and the other end is fixed to the support panel to thus connect the transfer shaft and the support panel, and
wherein a female Velcro tape is attached to the rotational panel, and a male Velcro tape is attached to the cleaning sheet so as to be detachably attached to the female Velcro tape.
